(19) United States
(12) Patent Application Publication
(10) Pub. No.: US 2018/0277064 A1
(43) Pub. Date: Sep. 27, 2018

(54) VEHICLE DISPLAY SAFETY SOFTWARE COMPLIANCE METHOD AND APPARATUS

(71) Applicant: CNH Industrial America LLC, New Holland, PA (US)

(72) Inventors: William R. Fleming, Hinsdale, IL (US); Clark E. Smith, Oswego, IL (US); Brendan P. McCarthy, Willowbrook, IL (US); Scott Eisfeldt, Lake Zurich, IL (US); Patrick T. Pang, Chandler, AZ (US); Eric J. Mayo, Plainfield, IL (US)

(73) Assignee: CNH Industrial America LLC, New Holland, PA (US)

(21) Appl. No.: 15/465,202

(22) Filed: Mar. 21, 2017

(51) Int. Cl. G09G 5/36; G06F 3/041; B60K 35/00; A01B 76/00

(52) U.S. Cl. CPC G09G 5/363; G06F 3/0416; B60K 35/00; B60K 2350/1028; G09G 2360/18; G09G 2354/00; G09G 2380/10; A01B 76/00

(57) ABSTRACT

A display system for use in a vehicle, the display system including first and second controllers in communication with each other and a display mounted in the vehicle. The display is communicatively coupled to the second controller and has a display area. The first controller executes the steps of incorporating a pattern in a set of data thereby producing a dataset; and communicating the dataset to the second controller. The second controller executes the steps of receiving the dataset from the first controller; rendering a graphic from the dataset; and making the rendered graphic available to the display for display in the display area. The first controller then additionally executes the steps of reading the rendered graphic; and evaluating the rendered graphic to see if the pattern has been correctly processed by the second controller.

### BACKGROUND OF THE INVENTION

### 1. Field of the Invention

The present invention relates to an agricultural system, and, more particularly, to a display regime for ensuring the integrity of what is sent to a display associated with a vehicle system.

### 2. Description of the Related Art

Modern farming practices have developed to improve the speed and efficiency of the farm equipment used to plant, maintain, and harvest crops. For example, tractors include a global positioning system (GPS) and a controller in the tractor is configured to provide a topographical view of a field and to identify the location of the tractor within the field based on the GPS coordinates. In addition, multiple agricultural implements may be connected to the tractor. During planting, for example, the tractor may pull an air cart having multiple containers including one or more types of seed and/or fertilizer. The tractor may also pull a planter to plant the seeds.

The controller on the tractor may be configured to control operation of the implements connected to the tractor. Different models of each implement may include varying operating parameters such as capacity, rate of application, or number of rows. The operating parameters may also depend, for example

The modern farmer faces the challenge of integrating many kinds of equipment starting with the vehicle itself, which can be coupled to all kinds of implements (planters, sprayers, seeders, tillage equipment etc.), and have various navigational controllers and high precision GPS receivers installed. These all lead to very complex setups and a large amount of data.

When data is transferred to a display, which can be operated by a controller and/or an operating system that is unknown or not trusted by the controller of the originator of the data, errors or system maladies may cause that which is displayed to not match the data that was originated. This can lead to misinterpreted information being displayed, which can lead to at least a lack of correct information being displayed and can result in an incorrect selection by the viewer of the information.

What is needed in the art is a robust system that allows for the presentation of accurately rendered data in an efficient manner on a display and the transmission of verified selections made by an operator in response to the graphical presentation.

### SUMMARY OF THE INVENTION

The present invention provides a display regime that uses an untrusted processor and/or operating system, yet the safety security of the overall system is maintained for a display system in a vehicle.

The invention in one form is directed to a display system for use in a vehicle, the display system including first and second controllers in communication with each other and a display mounted in the vehicle. The display is communicatively coupled to the second controller and has a display area. The first controller executes the steps of incorporating a pattern in a set of data thereby producing a dataset; and communicating the dataset to the second controller. The second controller executes the steps of receiving the dataset from the first controller; rendering a graphic from the dataset; and making the rendered graphic available to the display for display in the display area. The first controller then additionally executes the steps of reading the rendered graphic; and evaluating the rendered graphic to see if the pattern has been correctly processed by the second controller.

The invention in another form is directed to an agricultural vehicle having a chassis and a display system for use in the vehicle, the display system including first and second controllers in communication with each other and a display mounted in the vehicle. The display is communicatively coupled to the second controller and has a display area. The first controller executes the steps of incorporating a pattern in a set of data thereby producing a dataset; and communicating the dataset to the second controller. The second controller executes the steps of receiving the dataset from the first controller; rendering a graphic from the dataset; and making the rendered graphic available to the display for display in the display area. The first controller then additionally executes the steps of reading the rendered graphic; and evaluating the rendered graphic to see if the pattern has been correctly processed by the second controller.

The invention in yet another form is directed to a method of displaying information on a display of an agricultural system that includes a vehicle, with a display system coupled thereto. The display system includes a first controller, a second controller in communication with the first controller and the display, the display being communicatively coupled to the second controller and configured with a display area. The method including the steps of: incorporating a pattern in a set of data using the first controller thereby producing a dataset; communicating the dataset from the first controller to the second controller; receiving the dataset by the second controller; rendering a graphic from the dataset using the second controller; making the rendered graphic available to the display for display in the display area; reading the rendered graphic by the first controller; and evaluating the rendered graphic with the first controller to see if the pattern has been correctly processed by the second controller.

An advantage of the present invention is that an untrusted system can be used in a selection graphic display, yet the safety security level of the overall system is maintained.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a side view of an agricultural system in the form of a vehicle namely a tractor, that uses an embodiment of a display method of the present invention for the rendering of a selection on a display;

FIG. 2 is a functional block diagram of a display system used by the vehicle of FIG. 1; and

FIG. 3 is a functional flowchart of steps taken by the display system of FIGS. 1 and 2.

Corresponding reference characters indicate corresponding parts throughout the several views. The exemplification set out herein illustrates one embodiment of the invention, in one form, and such exemplification is not to be construed as limiting the scope of the invention in any manner.

### DETAILED DESCRIPTION OF THE INVENTION

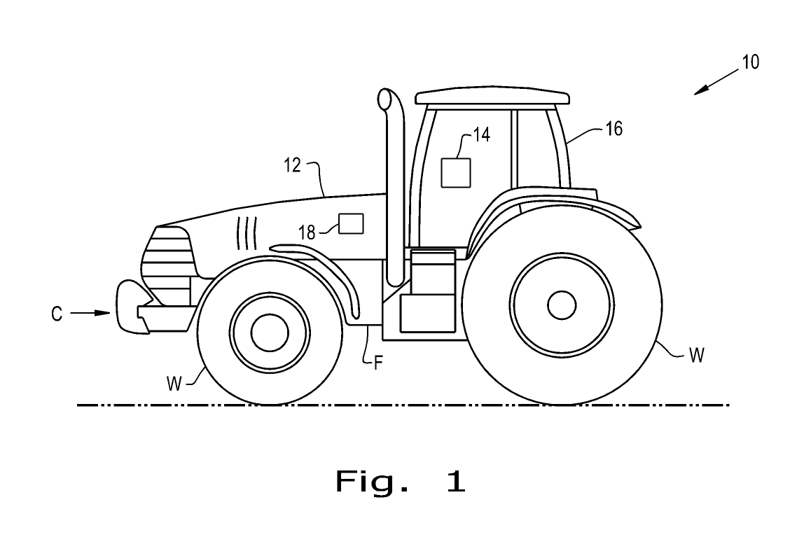

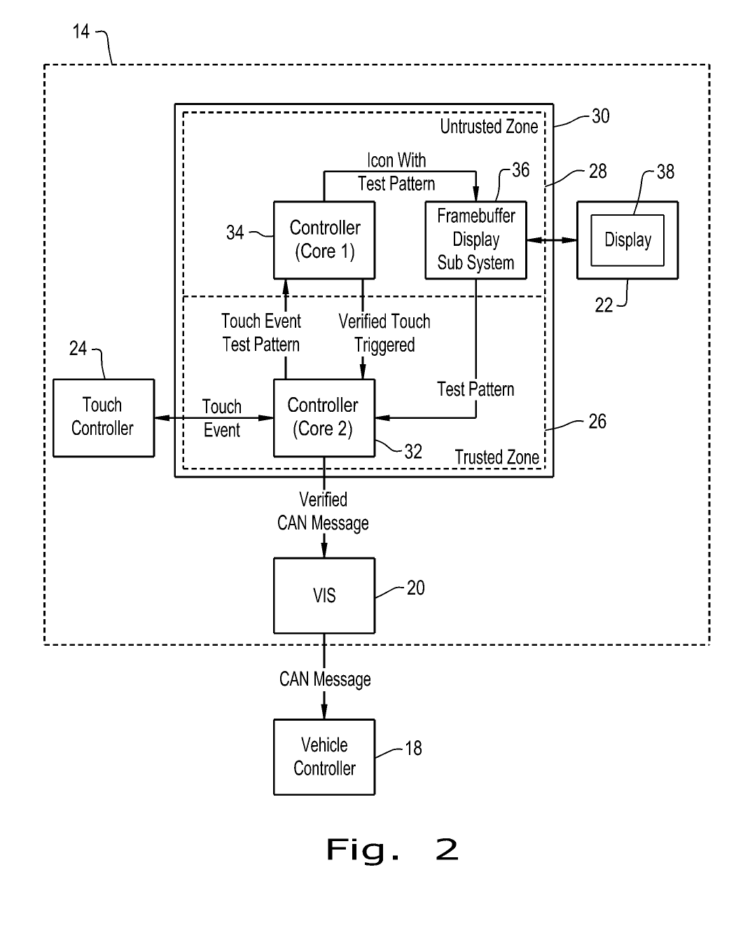

Referring now to the drawings, and more particularly to FIGS. 1 and 2, there is shown an embodiment of an agricultural system 10 including a tractor 12, with a display system 14 that is incorporated in a cab 16 of tractor 12. Tractor 12 has a chassis C, and a frame F that are carried by wheels W. Display system 14 is an interactive display system 14 configured to provide information to a user and allow the user to direct the operation of tractor 12 and/or an implement that may be connected thereto. A vehicle controller 18 receives information from sensors on tractor 12 and/or an implement that is coupled to tractor 12, processes, and performs control functions relative to tractor 12.

Controller 18 communicates to display system 14 using Controller Area Network (CAN) messages by way of a vehicle interface subsystem (VIS) 20. Display system 14 can store and display selected portions of that information and other stored information such as setup information and configuration selections on display 22. The displaying of information and control features on display 22 may take into account needed setup and configuration aspects of the agricultural system 10. A touch controller 24 may be coupled and integrated with display 22 or be a separate input device used by the operator to make a selection of a displayed item on display 22.

A trusted device 26 defines a trusted zone of hardware that operates trusted software algorithms and an untrusted device 28 in an untrusted zone. Untrusted device is not sinister or viral, but may be simply operating with a reduced level of security and may misconstrue or incorrectly render data sent to it. Trusted device 26 and untrusted device 28 may together be considered a communication system 30, and although schematically depicted as a single block these are typically separate devices that are simply in communication with each other.

Trusted device 26 includes a controller 32 that communicates to vehicle controller 18 by way of VIS 20 with instructions received from the operator by way of touch controller 24. When the operator makes a selection the touch event is conveyed to controller 32 and that selection can result in information being sent to vehicle controller 18 to alter the functioning of agricultural system 10. It is also contemplated that touch events received from touch controller 24 may be control or configuration information which controller 32 may store or use to configure itself.

Untrusted device 28 includes a controller 34 and a framebuffer display subsystem 36 that is accessible by both controller 32 and controller 34. Framebuffer display subsystem 36 contains information that is displayed on display 22, which can be in the form of rendered graphics.

Controller 32 communicates with controller 34 providing a rendered graphic for display in display area 38 of display 22. Controller 32 incorporates a pattern in a set of data to thereby produce a dataset and communicate this dataset to controller 34, which is depicted by the touch event test pattern message shown in FIG. 2. Controller 34 receives the dataset from controller 32 and renders a graphic from the dataset and places the rendered graphic in framebuffer display subsystem 36 to make the rendered graphic available to display 22 for display in display area 38. Controller 32 then reads the rendered graphic that is in framebuffer display subsystem 36 and evaluates the rendered graphic to see if the pattern that was incorporated into the dataset has been correctly processed by controller 34.

A function of the present invention is to meet a desired safety level for a display system 14, for example, display system 14 requires a SRL (Software Requirement Level)=1 level of safety, and open source software (such as Google Android® (used in untrusted device 28)) cannot practically be certified to meet SRL=1. To meet the needed level of safety the inventive solution that is described herein is to oversee the output of the “Application” software contained within the unsafe or untrusted zone.

The items to be protected (i.e. Safety goals) include: 1. That items rendered on the display 22 are correctly rendered; 2. That touch events are correctly interpreted (no false touches or missed touches) and 3. That CAN messages are correct (no missing or corrupt messages are allowed).

One embodiment of the inventive solution includes 1. The use of two hardware cores to realize a software partitioning. The Android® operating system will run on controller 34 (Core1) and the Safety Supervisor will run on controller 32 (Core 2) using SRL=1 compliant OS. 2. The shared “memory” interface in the solution, depicted here as framebuffer display subsystem 36 is the shared graphics frame buffer in the untrusted device 28, which may be a microprocessor 28. Core 1 writes the information (which can be a rendered graphic) and Core2 will check it for correctness. 3. When a touch event occurs, the Safety Supervisor (Core 2) will communicate a unique test pattern via a link. 4. A test pattern will be encoded into the graphics by controller 32 that is intended to be rendered by Android® (Core 1) and then pushed into the Graphics Frame Buffer 36. 5. The Safety supervisor (Core 2) will check to ensure that the test pattern has passed through the system unchanged, thereby verifying that the “unsafe” partition (not SRL compliant) did not corrupt the touch event or the graphics rendering. 6. CAN communications is protected by a specific E2E (End to End) protocol by the Safety Supervisor (Core 2).

Advantageously the present invention can be accomplished using a dual processor core in a microcontroller 30, to allow the use of open source software (Android®) for Application development.

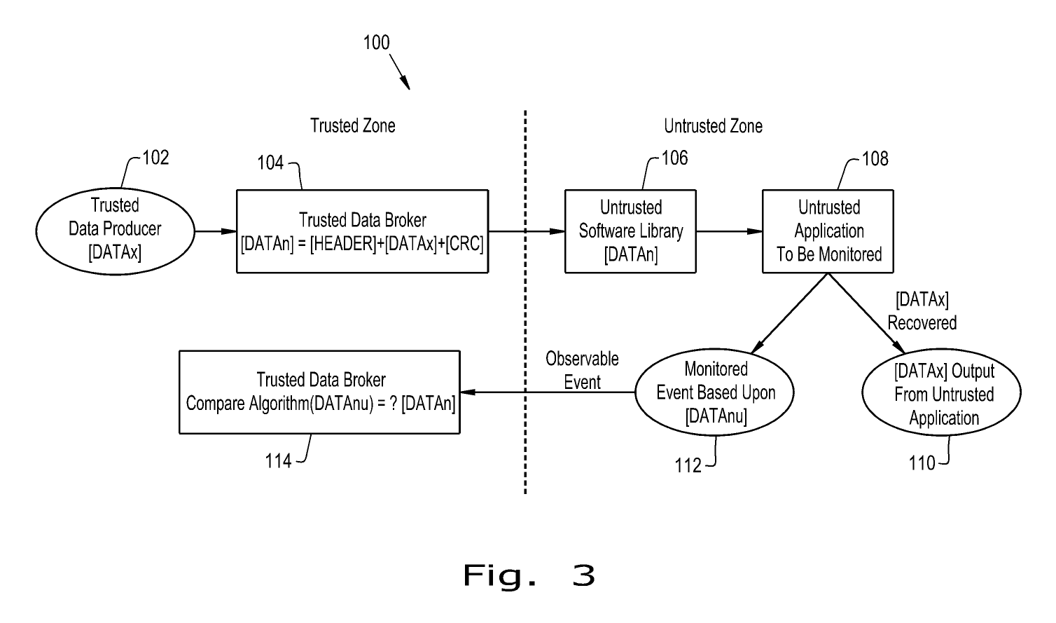

Now, additionally referring to FIG. 3 the steps taken by display system 14 are further illustrated in a method 100, which illustrates which steps or blocks take place in the trusted zone of trusted device 26 and those that take place in the untrusted zone of untrusted device 28. Trusted hardware device 32 produces data, identified as [DATAx], to denote the original data in block 102. At step 104 [DATAx] is consumed by a trusted software stack running on dedicated and trusted hardware 26. This software logic transforms [DATAx] to [DATAn] by adding a [HEADER] and a [CRC] in the logical format shown in block 104. The CRC (Cyclic Redundancy Check) is based on, and calculated from, the [HEADER]+[DATAx]. The resulting transform, [DATAn], is transmitted to a receiver (controller 34) at block 106 that must deliver the data to applications. This is often a low level driver level code of an operating system in controller 34.

At block 108 An application consumes the [DATAx] by processing it for its intended purpose and also placing the same data [DATAnu] in someplace where it can be examined such as shared memory of the hardware involved, depicted as framebuffer display subsystem 36 in FIG. 2. In block 112, the application notifies the Trusted Data Broker (controller 32) that new data was consumed which, in turn, signals the Trusted Data Broker to check the application's output that is stored in framebuffer display subsystem 36.

At block 110, the algorithm used by controller 34 to recover the data is used to process the data; [DATAnu]. In the present example controller 34 causes this data to be placed in framebuffer 36 in the form of visual data and touch input data from an I2C bus.

At block 114 the Trusted Data Broker, in the form of controller 32, reads back the data [DATAnu], repeats the calculations performed in step 104 and compares the two [CRC] values. In other words, the CRC of [DATAnu] will match [DATAx] if there has been no corruption or tampering of the original [DATAx] as it flowed through steps 106-112. Mismatched CRCs are an indication of data corruption of some type, and additional action can be taken such as refusing to act on the input and informing an operator of the issue.

In addition to the steps discussed above, the [HEADER] includes a rolling counter and a Timeout. The trusted data broker (controller 32), by way of a time stamp, will allow a predetermined amount of time for the observable event to be received before classifying the data as corrupt and/or missing.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A display system for use in a vehicle, the display system comprising:
a first controller;
a second controller in communication with the first controller; and
a display mounted in the vehicle, the display being communicatively coupled to the second controller and configured with a display area, the first controller executing the steps of:
incorporating a pattern in a set of data thereby producing a dataset; and
communicating the dataset to the second controller;
wherein the second controller executes the steps of:
receiving the dataset from the first controller;
rendering a graphic from the dataset; and
making the rendered graphic available to the display for display in the display area;
wherein the first controller additionally executes the steps of:
reading the rendered graphic; and
evaluating the rendered graphic to see if the pattern has been correctly processed by the second controller.

2. The display system of claim 1, wherein the first controller is a trusted processor system and the second controller is an unprotected processor system.

3. The display system of claim 2, wherein the graphic is a selection graphic.

4. The display system of claim 3, further comprising a touch controller associated with the display.

5. The display system of claim 4, wherein the first controller additionally executes the steps of:
receiving an input from the touch controller; and
acting on the input if the pattern was correctly processed in the rendered graphic.

6. The display system of claim 5, wherein the first controller additionally executes the step of sending a control message to a vehicle controller dependent upon the input.

7. The display system of claim 5, wherein the first controller additionally executes the step of rejecting the input if the pattern was not correctly processed in the rendered graphic.

8. The display system of claim 1, wherein the pattern is not visually apparent to a user of the display.

9. An agricultural vehicle, comprising:
a chassis;
a display system carried by the chassis, the display system including:
a first controller;
a second controller in communication with the first controller;
a display mounted in the vehicle, the display being communicatively coupled to the second controller and configured with a display area, the first controller executing the steps of:
incorporating a pattern in a set of data thereby producing a dataset; and
communicating the dataset to the second controller;
wherein the second controller executes the steps of:
receiving the dataset from the first controller;
rendering a graphic from the dataset; and
making the rendered graphic available to the display for display in the display area;
wherein the first controller additionally executes the steps of:
reading the rendered graphic; and
evaluating the rendered graphic to see if the pattern has been correctly processed by the second controller.

10. The agricultural vehicle of claim 9, wherein the first controller is a trusted processor system and the second controller is an untrusted processor system.

11. The agricultural vehicle of claim 10, wherein the graphic is a selection graphic.

12. The agricultural vehicle of claim 11, wherein the display system further includes a touch controller associated with the display.

13. The agricultural vehicle of claim 12, wherein the first controller additionally executes the steps of:
receiving an input from the touch controller; and
acting on the input if the pattern was correctly processed in the rendered graphic.

14. The agricultural vehicle of claim 13, wherein the first controller additionally executes the step of sending a control message to a vehicle controller dependent upon the input.

15. The agricultural vehicle of claim 13, wherein the first controller additionally executes the step of rejecting the input if the pattern was not correctly processed in the rendered graphic.

16. The agricultural vehicle of claim 9, wherein the pattern is not visually apparent to a user of the display.

17. A method of displaying information on a display of an agricultural system that includes a vehicle, with a display system coupled thereto, the display system including a first controller, and a second controller in communication with the first controller and the display, the display being communicatively coupled to the second controller and configured with a display area, the method comprising the steps of:
incorporating a pattern in a set of data using the first controller thereby producing a dataset; and
communicating the dataset from the first controller to the second controller;
receiving the dataset by the second controller;
rendering a graphic from the dataset using the second controller;
making the rendered graphic available to the display for display in the display area;
reading the rendered graphic by the first controller; and
evaluating the rendered graphic with the first controller to see if the pattern has been correctly processed by the second controller.

18. The method of claim 17, wherein the first controller is a trusted processor system and the second controller is an untrusted processor system.

19. The method of claim 18, wherein the graphic is a selection graphic.

20. The method of claim 19, wherein the first controller additionally executes the steps of:
receiving an input from a touch controller; and
acting on the input if the pattern was correctly processed in the rendered graphic.
